(19) United States
(12) Patent Application Publication
(10) Pub. No.: US 2025/0294537 A1
(43) Pub. Date: Sep. 18, 2025

(54) NETWORK DEPLOYMENT BASED ON PARTIALLY OVERLAPPED CARRIERS

(71) Applicant: Telefonaktiebolaget LM Ericsson (publ), Stockholm (SE)

(72) Inventors: Jie CHEN, Beijing (CN); Huichen WANG, Beijing (CN); Pen-Shun LU, Beijing (CN); Chen ZHANG, Beijing (CN)

(73) Assignee: Telefonaktiebolaget LM Ericsson (publ), Stockholm (SE)

(21) Appl. No.: 18/860,294

(22) PCT Filed: Apr. 27, 2022
(86) PCT No.: PCT/CN2022/089522

§ 371 Date: Oct. 25, 2024

(51) Int. Cl. H04W 72/0453; H04L 5/00

(52) U.S. Cl. CPC H04W 72/0453; H04L 5/001; H04L 5/0044

(57) ABSTRACT

The present disclosure is related to a RAN node and a method for network deployment based on partially overlapped carriers. A method at a RAN node for serving a first cell with a first carrier that is partially overlapped with a second carrier of a second cell comprises: broadcasting or transmitting, to one or more UEs, a first part of data in a first part of the first carrier that is overlapped with the second carrier and a second part of the data in a second part of the first carrier that is not overlapped with the second carrier.

### TECHNICAL FIELD

The present disclosure is related to the field of telecommunication, and in particular, to a Radio Access Network (RAN) node and a method for network deployment based on partially overlapped carriers.

### BACKGROUND

Narrowband Internet of Things (NB-IoT) is a cellular low-power wide-area (LPWA) connectivity standard that enables IoT devices to send their data directly to the cloud without a gateway in between. “Low power” means that IoT devices can run on battery for like 10+ years. “Wide area” means that cell coverage is improved such that, for example, smart meters in basements can connect to the network reliably.

Traditional cellular standards were focused on either voice or bandwidth-intensive low-latency data applications. These are not scalable for IoT due to reasons of cost, coverage, device density, and power. NB-IoT reduces complexity, limits bandwidth, and caps maximum data rates. This is possible because IoT sensor devices are tolerant to delays, require minimum mobility, and operate at low data rates. Smart metering, asset tracking, wearables including health monitoring, facilities management, intruder and fire alarms, smart dustbins, smart street lighting, connected appliances at home or factories, or the like are some use cases of NB-IoT.

NB-IoT is defined in 3^{rd} Generation Partnership Project (3GPP) Release 13 based on same numerology as LTE, to reduce the complexity of User Equipment (UE) with narrow bandwidth and low traffic requirement. An NB-IoT cell consists of an anchor carrier and zero or more non-anchor carriers. One NB-IoT carrier consists of 12 subcarriers and each has 15 kHz so totally 180 kHz, which is same as one Physical Resource Block (PRB) of Long Term Evolution (LTE). There are 3 deployment modes defined, guard-band, in-band, and standalone. Guard-band mode is defined to deploy an NB-IoT carrier in a guard-band between an edge of LTE transmission bandwidth and a corresponding edge of channel bandwidth. In-band mode is defined to deploy an NB-IoT carrier in the LTE transmission bandwidth. Standalone mode is not associated to any LTE carrier, and is usually located in a narrow frequency fragment, for example in a re-farmed Global System for Mobile Communication (GSM) frequency band.

However, it is difficult to deploy an NB-IoT carrier in a guard-band of an LTE carrier having a narrow bandwidth (such as 3 MHz or 5 MHz), and PRB positions in the LTE carrier for deploying the NB-IoT carrier in the in-band mode are limited.

### SUMMARY

According to a first aspect of the present disclosure, a method at a RAN node for serving a first cell with a first carrier that is partially overlapped with a second carrier of a second cell is provided. The method comprises: broadcasting or transmitting, to one or more UEs, a first part of data in a first part of the first carrier that is overlapped with the second carrier and a second part of the data in a second part of the first carrier that is not overlapped with the second carrier.

In some embodiments, the first carrier is an anchor carrier of the first cell. In some embodiments, the second carrier has a bandwidth of 3 MHz, 5 MHz, 10 MHz, 15 MHz, or 20 MHz.

In some embodiments, when the second carrier has a bandwidth of 3 MHz, the first part of the first carrier has 10 subcarriers while the second part of the first carrier has 2 subcarriers that are overlapped with a guard-band associated with the second carrier. In some embodiments, when the second carrier has a bandwidth of 3 MHz, at least one of following is true: with type 0 resource allocation for the second carrier, a resource block group (RBG) comprising 2 PRBs on the lower side of the second carrier cannot be scheduled for the second carrier when the first carrier is on the lower side of the second carrier; and with type 0 resource allocation for the second carrier, an RBG comprising 1 PRB on the upper side of the second carrier cannot be scheduled for the second carrier when the first carrier is on the upper side of the second carrier. In some embodiments, when the second carrier has a bandwidth of 3 MHz, at least one of following is true: broadcasting a message indicating that a channel raster offset of 2.5 kHz is to be applied at any UE to access the first carrier when the first carrier is on the lower side of the second carrier; and broadcasting a message indicating that a channel raster offset of −2.5 kHz is to be applied at any UE to access the first carrier when the first carrier is on the upper side of the second carrier.

In some embodiments, when the second carrier has a bandwidth of 5 MHz, at least one of following is true: the first part of the first carrier has 10 subcarriers while the second part of the first carrier has 2 subcarriers that are overlapped with a guard-band associated with the second carrier; and the first part of the first carrier has 3 subcarriers while the second part of the first carrier has 9 subcarriers that are overlapped with a guard-band associated with the second carrier. In some embodiments, the second carrier has a bandwidth of 5 MHz, at least one of following is true: with type 0 resource allocation for the second carrier, an RBG comprising 2 PRBs on the lower side of the second carrier cannot be scheduled for the second carrier when the first carrier is on the lower side of the second carrier; and with type 0 resource allocation for the second carrier, an RBG comprising 1 PRB on the upper side of the second carrier cannot be scheduled for the second carrier when the first carrier is on the upper side of the second carrier. In some embodiments, when the second carrier has a bandwidth of 5 MHz, at least one of following is true: broadcasting a message indicating that a channel raster offset of 2.5 kHz is to be applied at any UE to access the first carrier when the first carrier is on the lower side of the second carrier and has 2 subcarriers overlapped with a guard-band associated with the second carrier; broadcasting a message indicating that a channel raster offset of −2.5 kHz is to be applied at any UE to access the first carrier when the first carrier is on the upper side of the second carrier and has 2 subcarriers overlapped with a guard-band associated with the second carrier; broadcasting a message indicating that a channel raster offset of −2.5 kHz is to be applied at any UE to access the first carrier when the first carrier is on the lower side of the second carrier and has 9 subcarriers overlapped with a guard-band associated with the second carrier; and broadcasting a message indicating that a channel raster offset of 2.5 kHz is to be applied at any UE to access the first carrier when the first carrier is on the upper side of the second carrier and has 9 subcarriers overlapped with a guard-band associated with the second carrier.

In some embodiments, the method further comprises: broadcasting a message indicating that the first carrier has an operation mode of “inband-DifferentPCI” with respect to the second carrier. In some embodiments, at least one of following is true: N_{ID}^{Ncell} mod 6=(N_{ID}^{Cell}+2) mod 6 when the second carrier has a bandwidth of 3 MHz, the first carrier is on the lower side of the second carrier and has 2 subcarriers overlapped with a guard-band associated with the second carrier, and 1 Cell-specific Reference Signal (CRS) port is configured for the second carrier; N_{ID}^{Ncell} mod 6=(N_{ID}^{Cell}−2) mod 6 when the second carrier has a bandwidth of 3 MHz, the first carrier is on the upper side of the second carrier and has 2 subcarriers overlapped with a guard-band associated with the second carrier, and 1 CRS port is configured for the second carrier; N_{ID}^{Ncell} mod 3=(N_{ID}^{Cell}+2) mod 3 when the second carrier has a bandwidth of 3 MHz, the first carrier is on the lower side of the second carrier and has 2 subcarriers overlapped with a guard-band associated with the second carrier, and 2 or 4 CRS ports are configured for the second carrier; N_{ID}^{Ncell} mod 3=(N_{ID}^{Cell}−2) mod 3 when the second carrier has a bandwidth of 3 MHz, the first carrier is on the upper side of the second carrier and has 2 subcarriers overlapped with a guard-band associated with the second carrier, and 2 or 4 CRS ports are configured for the second carrier; N_{ID}^{Ncell} mod 6=(N_{ID}^{Cell}+2) mod 6 when the second carrier has a bandwidth of 5 MHz, the first carrier is on the lower side of the second carrier and has 2 subcarriers overlapped with a guard-band associated with the second carrier, and 1 CRS port is configured for the second carrier; N_{ID}^{Ncell} mod 6=(N_{ID}^{Cell}−2) mod 6 when the second carrier has a bandwidth of 5 MHz, the first carrier is on the upper side of the second carrier and has 2 subcarriers overlapped with a guard-band associated with the second carrier, and 1 CRS port is configured for the second carrier; N_{ID}^{Ncell} mod 3=(N_{ID}^{Cell}+2) mod 3 when the second carrier has a bandwidth of 5 MHz, the first carrier is on the lower side of the second carrier and has 2 subcarriers overlapped with a guard-band associated with the second carrier, and 2 or 4 CRS ports are configured for the second carrier; N_{ID}^{Ncell} mod 3=(N_{ID}^{Cell}−2) mod 3 when the second carrier has a bandwidth of 5 MHz, the first carrier is on the upper side of the second carrier and has 2 subcarriers overlapped with a guard-band associated with the second carrier, and 2 or 4 CRS ports are configured for the second carrier; N_{ID}^{Ncell} mod 6=(N_{ID}^{Cell}+3) mod 6 when the second carrier has a bandwidth of 5 MHz, the first carrier is on the lower side of the second carrier and has 9 subcarriers overlapped with a guard-band associated with the second carrier, and 1 CRS port is configured for the second carrier; N_{ID}^{Ncell} mod 6=(N_{ID}^{Cell}−3) mod 6 when the second carrier has a bandwidth of 5 MHz, the first carrier is on the upper side of the second carrier and has 9 subcarriers overlapped with a guard-band associated with the second carrier, and 1 CRS port is configured for the second carrier; N_{ID}^{Ncell} mod 3=N_{ID}^{Cell} mod 3 when the second carrier has a bandwidth of 5 MHz, the first carrier is on the lower side of the second carrier and has 9 subcarriers overlapped with a guard-band associated with the second carrier, and 2 or 4 CRS ports are configured for the second carrier; N_{ID}^{Ncell} mod 3=N_{ID}^{Cell} mod 3 when the second carrier has a bandwidth of 5 MHz, the first carrier is on the upper side of the second carrier and has 9 subcarriers overlapped with a guard-band associated with the second carrier, and 2 or 4 CRS ports are configured for the second carrier, wherein N_{ID}^{Ncell} refers to the Physical layer Cell Identity (PCI) of the first cell and N_{ID}^{Cell} refers to the PCI of the second cell.

In some embodiments, the starting symbol for Narrowband Physical Downlink Shared Channel (NPDSCH) and/or Narrowband Physical Downlink Control Channel (NPDCCH) in the subcarriers of the second part of the first carrier is same as that in the subcarriers of the first part of the first carrier. In some embodiments, one or more resource elements (REs) in the first carrier are reserved for CRS transmission associated with the second carrier. In some embodiments, the one or more reserved REs comprise at least one RE in the second part of the first carrier. In some embodiments, the one or more reserved REs comprise no RE in the second part of the first carrier. In some embodiments, the data comprises one or more Narrowband Reference Signal (NRS) at least. In some embodiments, the first carrier is an NB-IoT carrier and the second carrier is an Evolved Universal Terrestrial Radio Access (E-UTRA) carrier. In some embodiments, the second cell is also served by the RAN node.

According to a second aspect of the present disclosure, a RAN node is provided. The RAN node comprises: a processor; a memory storing instructions which, when executed by the processor, cause the processor to perform the method of any of the first aspect.

According to a third aspect of the present disclosure, a RAN node is provided. The RAN node serves a first cell with a first carrier that is partially overlapped with a second carrier of a second cell. The RAN node comprises: a communicating module configured to broadcast or transmit, to one or more UEs, a first part of data in a first part of the first carrier that is overlapped with the second carrier and a second part of the data in a second part of the first carrier that is not overlapped with the second carrier. In some embodiments, the RAN node comprises one or more further modules configured to perform the method of any of the first aspect.

According to a fourth aspect of the present disclosure, a computer program comprising instructions is provided. The instructions, when executed by at least one processor, cause the at least one processor to carry out the method of any of the first aspect.

According to a fifth aspect of the present disclosure, a carrier containing the computer program of the fourth aspect is provided. In some embodiments, the carrier is one of an electronic signal, optical signal, radio signal, or computer readable storage medium.

### BRIEF DESCRIPTION OF THE DRAWINGS

FIG. 1 is a diagram illustrating an exemplary telecommunications network in which an eNB may be operated according to an embodiment of the present disclosure.

FIG. 2 is a diagram illustrating different deployment modes for an NB-IoT carrier.

FIG. 3 is a diagram illustrating an exemplary deployment in which an NB-IoT carrier is deployed in a guard-band of a 5 MHz LTE carrier.

FIG. 4 is a diagram illustrating exemplary CRS and NRS positions in resource grids in an in-band deployment mode.

FIG. 5 is a diagram illustrating an exemplary deployment in which an NB-IoT carrier is deployed partially overlapped with a guard-band of a 3 MHz LTE carrier according to an embodiment of the present disclosure.

FIG. 6 is a diagram illustrating exemplary deployments in each of which an NB-IoT carrier is deployed partially overlapped with a guard-band of a 5 MHz LTE carrier according to some embodiments of the present disclosure.

FIG. 7A and FIG. 7B are diagrams illustrating exemplary CRS and NRS positions in resource grids in a deployment mode according to some embodiments of the present disclosure.

FIG. 8 is a flow chart illustrating an exemplary method at a RAN node for serving a first cell with a first carrier that is partially overlapped with a second carrier of a second cell according to an embodiment of the present disclosure.

FIG. 9 schematically shows an embodiment of an arrangement which may be used in a RAN node according to an embodiment of the present disclosure.

FIG. 10 is a block diagram of an exemplary RAN node according to an embodiment of the present disclosure.

FIG. 11 schematically illustrates a telecommunication network connected via an intermediate network to a host computer according to an embodiment of the present disclosure.

FIG. 12 is a generalized block diagram of a host computer communicating via a base station with a user equipment over a partially wireless connection according to an embodiment of the present disclosure.

FIG. 13 to FIG. 16 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 4G LTE/NB-IoT, the present disclosure is not limited thereto. In fact, as long as network deployment based on partially overlapped carriers is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), LTE-M, LTE-Advance (LTE-A), or 5G New Radio, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “RAN node” used herein may refer to a network node, a base station, a base transceiver station, an access point, a hot spot, a NodeB, an Evolved NodeB (eNB), a gNB, a network element, or any other equivalents.

Further, although some embodiments are described in the context of “NB-IoT”, the present disclosure is not limited thereto. In some other embodiments, another type of RAT may be involved, for example, LTE-M, Wi-Fi, Bluetooth, etc.

Further, following 3GPP documents are incorporated herein by reference in their entireties:
3GPP TS 36.213 V17.0.0 (2021-12), Technical Specification, 3rd Generation Partnership Project; Technical Specification Group Radio Access Network; Evolved Universal Terrestrial Radio Access (E-UTRA); Physical layer procedures (Release 17); and
3GPP TS 36.331 V16.7.0 (2021-12), Technical Specification, 3rd Generation Partnership Project; Technical Specification Group Radio Access Network; Evolved Universal Terrestrial Radio Access (E-UTRA); Radio Resource Control (RRC); Protocol specification (Release 16).

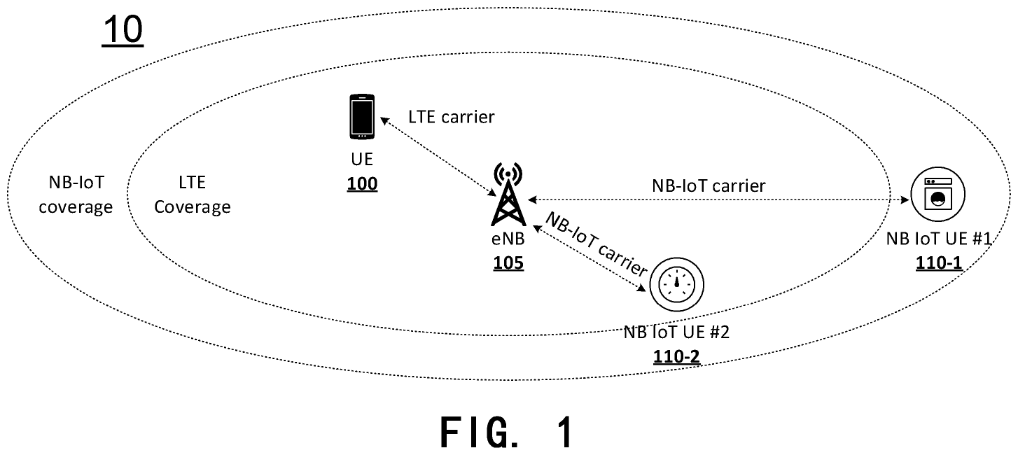

FIG. 1 is a diagram illustrating an exemplary telecommunications network 10 in which one or more UEs and an eNB 105 may be operated according to an embodiment of the present disclosure. In some embodiments, the one or more UEs may comprise (but not limited to) a UE 100 (such as a smart phone), an NB-IoT UE #1 110-1 (such as a smart home appliance (e.g., a smart washing machine, a smart air conditioner, etc.)), and an NB-IoT UE #2 110-2 (such as a smart meter (e.g., a smart electric meter, a smart gas meter, etc.)). As shown in FIG. 1, the UE 100 and the NB-IoT UEs 110-1/110-2 may be served by the eNB 105 with different carriers. For example, the UE 100 may be served by the eNB 105 with one or more LTE carriers, while the NB-IoT UEs 110-1/110-2 may be served by the eNB 105 with one or more NB-IoT carriers.

Please note that although FIG. 1 shows one UE 100 and two NB-IoT UEs 110-1/110-2, the present disclosure is not limited thereto. In some other embodiments, any number of UEs/NB-IoT UEs and/or any number of eNBs may be comprised in the network 10. Further, although FIG. 1 shows specific types of UE/NB-IoT UEs, the present disclosure is not limited thereto. In some other embodiments, the NB-IoT UEs may be of other types and/or usages, such as field sensors, smart metering, asset tracking, wearables including health monitoring, facilities management, intruder and fire alarms, smart dustbins, smart street lighting, connected appliances at home or factories, or the like.

Further, although FIG. 1 shows that the same eNB 105 serves both the UE 100 and the NB-IoT UE #1 110-1 and the NB-IoT UE #2 110-2, the present disclosure is not limited thereto. In some other embodiments, these UEs can be served by different RAN nodes. For example, the UE 100 may be served by a first eNB with a first LTE carrier, while the NB-IoT UE #1 110-1 and the NB-IoT UE #2 110-2 may be served by a second eNB with a second NB-IoT carrier. For another example, the UE 100, the NB-IoT UE #1 110-1, and the NB-IoT UE #2 110-2 may be served by three different eNBs with three different carriers.

Further, although the embodiment of FIG. 1 is shown and described in the context of “LTE/NB-IoT”, the present disclosure is not limited thereto. As also mentioned above, the embodiments described herein may also be applicable to other RATs, as long as partially overlapped carriers are involved. Furthermore, in some other embodiments, the network 10 may comprise additional nodes, less nodes, or some variants of the existing nodes shown in FIG. 1. For example, in a network with the 5G architecture, the entities (e.g., a gNB) which perform these functions may be different from those (e.g., the eNB 105) shown in FIG. 1. For another example, in a network with a mixed 4G/5G architecture, some of the entities (e.g., ng-eNB) may be same as those shown in FIG. 1, and others may be different.

As shown in FIG. 1, the UE 100 and/or the NB-IoT UEs 110-1/110-2 may be communicatively connected to the eNB 105 which in turn may be communicatively connected to a corresponding Core Network (CN) and then the Internet, such that the UEs 100 may finally communicate its user plane data with other devices outside the network 10, for example, via the eNB 105.

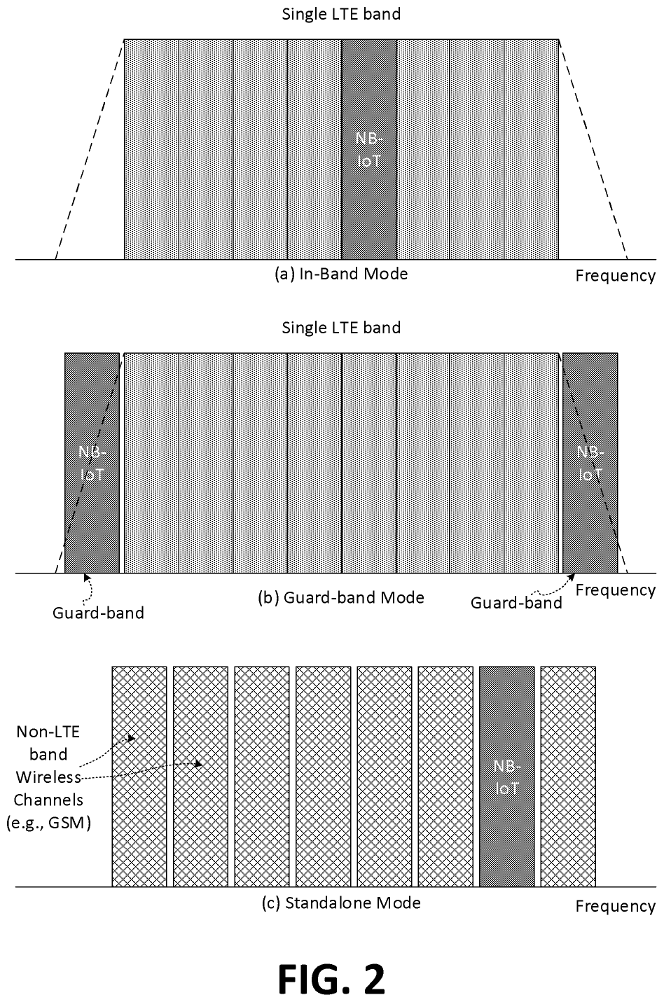

As shown in FIG. 1, the NB-IoT coverage/cell may coexist with the LTE coverage/cell, and therefore their deployment must be carefully designed to avoid any possible resource confliction. As mentioned above, three deployment modes are provided, which will be described in detail with reference to FIG. 2.

FIG. 2 is a diagram illustrating different deployment modes for an NB-IoT carrier. As shown in FIG. 2, there are three deployment modes for an NB-IoT carrier: “In-band” mode, “guard-band” mode, and “standalone” mode.

In-band Mode: In this mode, an NB-IoT carrier may be deployed within a legacy LTE band as shown in (a) of FIG. 2, for example, when 1 RB is reserved somewhere in the legacy LTE band.

Guard-band Mode: For an LTE carrier with more than 200 kHz guard-band space which is larger than 180 KHz can be used to deploy an NB-IoT carrier with a residual guard between the NB-IoT carrier and the bandwidth edge of the LTE carrier. The guard-band mode is to deploy an NB-IoT carrier in the space that is reserved for the guard-band of legacy LTE bands, as shown in (b) of FIG. 2.

Standalone Mode. In previous two modes, an NB-IoT carrier coexists with an existing legacy LTE band. However, there is another case where it is deployed completely independent from any legacy LTE band. In an extreme case, an NB-IoT carrier may be deployed in completely free space in the spectrum. However, in practical sense this mode of operation is intended to reserve (free up) a GSM channel and deploy the NB-IoT carrier in that space, as shown in (c) of FIG. 2.

As mentioned above, an NB-IoT cell always consists of an anchor carrier. A downlink anchor carrier always includes synchronization signals and system information, such as Narrowband Primary Synchronization Signal (NPSS)/Narrowband Secondary Synchronization Signal (NSSS)/Narrowband Physical Broadcast Channel (NPBCH)/System Information Block-Narrowband (SIB-NB). An NB-IoT UE will perform cell search on the anchor carrier. To save the cell search time, it's required by 3GPP to allocate an NB-IoT anchor carrier close to 100 kHz raster, and therefore limited positions are available for the guard-band mode and the in-band mode to co-exist with LTE. Further, because LTE Direct Current (DC) carrier exists, there is a +2.5 kHz or +7.5 kHz offset to the 100 kHz raster and this offset information is broadcasted in MasterInformationBlock-NB. This is highlighted in the below from TS 36.331:

MasterinformationBlock-NB

-- ASN1START

| | |
|---|---|
| MasterInformationBlock-NB ::= | SEQUENCE { |
| systemFrameNumber-MSB-r13 | BIT STRING (SIZE (4)), |
| hyperSFN-LSB-r13 | BIT STRING (SIZE (2)), |
| schedulingInfoSIB1-r13 | INTEGER (0..15), |
| systemInfoValueTag-r13 | INTEGER (0..31), |
| ab-Enabled-r13 | BOOLEAN, |
| operationModeInfo-r13 | CHOICE { |
| inband-SamePCI-r13 | Inband-SamePCI-NB-r13, |
| inband-DifferentPCI-r13 | Inband-DifferentPCI-NB-r13, |
| guardband-r13 | Guardband-NB-r13, |
| standalone-r13 | Standalone-NB-r13 |

},

| | |
|---|---|
| additionalTransmissionSIB1-r15 | BOOLEAN, |
| ab-Enabled-5GC-r16 | BOOLEAN, |
| spare | BIT STRING (SIZE (9)) |

}

| | |
|---|---|
| Guardband-NB-r13 ::= | SEQUENCE { |
| rasterOffset-r13 | ChannelRasterOffset-NB-r13, |
| spare | BIT STRING (SIZE (3)) |

}

| | |
|---|---|
| Inband-SamePCI-NB-r13 ::= | SEQUENCE { |
| eutra-CRS-SequenceInfo-r13 | INTEGER (0..31) |

}

| | |
|---|---|
| Inband-DifferentPCI-NB-r13 ::= | SEQUENCE { |
| eutra-NumCRS-Ports-r13 | ENUMERATED {same, four}, |
| rasterOffset-r13 | ChannelRasterOffset-NB-r13, |
| spare | BIT STRING (SIZE (2)) |

}

| | |
|---|---|
| Standalone-NB-r13 ::= | SEQUENCE { |
| spare | BIT STRING (SIZE (5)) |

}
-- ASN1STOP

LTE DC carrier is exactly on the 100 kHz raster, and in-band carrier allocation is aligned to LTE PRB according to 3GPP definition. Since a downlink anchor carrier also have 100 kHz raster requirement, so limited PRBs can be used as an anchor carrier for NB-IoT in-band mode. The candidate downlink PRB positions and related raster offsets for different host LTE bandwidth are shown in Table 1.

TABLE 1
Possible Downlink Anchor PRBs

| | LTE Cell Bandwidth | | | | | |
|---|---|---|---|---|---|---|
| | 1.4 MHz | 3 MHz | 5 MHz | 10 MHz | 15 MHz | 20 MHz |
| PRB indices with | N/A | N/A | N/A | 4, 9, 14, | N/A | 4, 9, 14, 19, 24, 29, 34, |
| 2.5 kHz offset | | | | 19, 30, 35, | | 39, 44, 55, 60, 65, 70, |
| | | | | 40, 45 | | 75, 80, 85, 90, 95 |
| PRB indices with | N/A | 2, 12 | 2, 7, 17, | N/A | 2, 7, 12, 17, 22, 27, | N/A |
| 7.5 kHz offset | | | 22 | | 32, 42, 47, 52, 57, | |
| | | | | | 62, 67, 72 | |

With above anchor PRB positions for in-band mode, it needs to occupy one RBG when type 0 resource allocation is used. The RBG size is 2 for both 3 MHz (15 PRBs) and 5 MHz (25 PRBs) bandwidth according to TS 36.213 Table 7.1.6.1-1.

TABLE 7.1.6.1-1
Type 0 resource allocation RBG size
vs. Downlink System Bandwidth

| System Bandwidth | RBG Size |
|---|---|
| N_{RB}^{DL} | (P) |
| ≤10 | 1 |
| 11-26 | 2 |
| 27-63 | 3 |
| 64-110 | 4 |

When an NB-IoT carrier is deployed in the guard-band mode, with the 100 kHz raster requirement for downlink anchor carrier, for even PRB bandwidth (10 MHz or 20 MHz), the closest NB-IoT anchor carrier can be adjacent to the edge PRB of the host LTE cell; for odd PRB bandwidth (3 MHz or 5 MHz or 15 MHz), the closest NB-IoT anchor carrier needs to have a gap of 45 kHz (3 subcarriers) to the edge PRB of the host LTE cell.

The guard-band of LTE 3 MHz is only 142.5 kHz on each side, it is smaller than one PRB and therefore a guard-band mode NB-IoT carrier cannot be deployed.

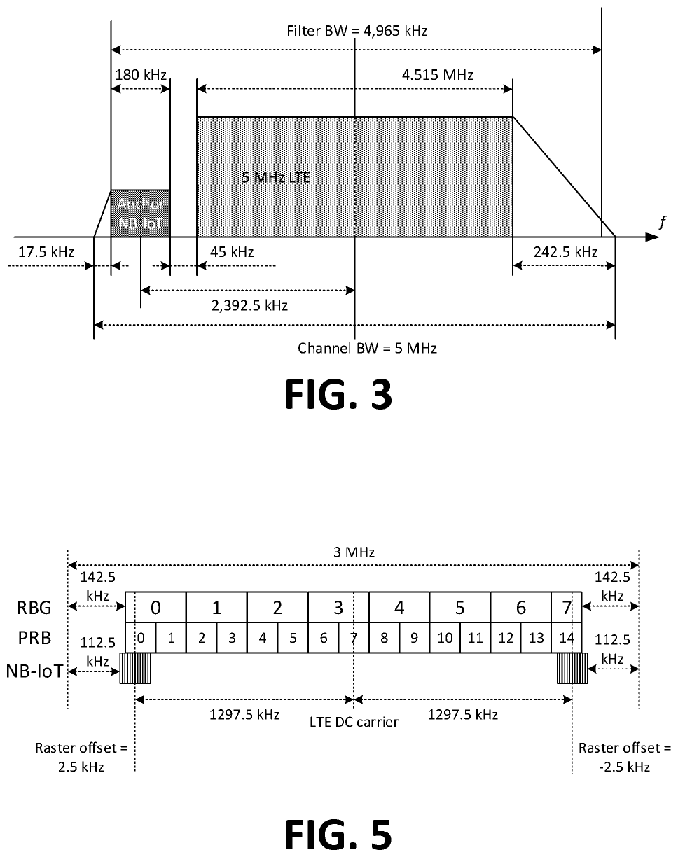

FIG. 3 is a diagram illustrating an exemplary deployment in which an NB-IoT carrier is deployed in a guard-band of a 5 MHz LTE carrier. As shown in FIG. 3, the host LTE carrier may have a channel bandwidth of 5 MHz including a transmission bandwidth of 4.515 MHz and a guard-band of only 242.5 kHz on each edge of the host LTE carrier. When an anchor NB-IoT carrier is deployed in the guard-band of the host LTE carrier (e.g., in the left guard-band shown in FIG. 3), it shall be spaced apart from the transmission bandwidth of the host LTE carrier by at least 45 kHz and also aligned with 100 kHz raster. In such a case, there is only 242.5−45−180=17.5 kHz guard-band left to the whole 5 MHz bandwidth edge, as shown in FIG. 3. In such a case, it is very difficult to design a filter to fulfill the 3GPP Adjacent Channel Leakage Ratio (ACLR) requirement.

Therefore the guard-band mode basically cannot be used for a host LTE carrier with a bandwidth of 3 MHz and 5 MHz in practice.

For guard-band and standalone modes, all the 14 downlink symbols can be used for NB-IoT, while, for in-band mode, less than 14 symbols can be used since LTE control region is spreading into the whole bandwidth. The start symbol is defined by the eutraControlRegionSize-r13 which is broadcasted in SIB1-NB for an anchor carrier. Further, the LTE CRS also needs to be reserved for in-band mode to avoid interference to each other. The reserved CRS positions are described in 3GPP TS 36.211 chapter 10.2.4.4 as below “by replacing N_{ID}^{cell} with N_{ID}^{Ncell} which are the PCIs of the LTE and NB-IoT cells separately in the calculation of v_{shift} in clause 6.10.1.2”, which means NRS and CRS are in the same frequency subcarrier positions. In this way, a UE can perform the rate-matching and automatically skip the REs when performing resource mapping.

With this CRS and NRS position restriction, it needs to fulfill the following rule of N_{ID}^{Ncell} mod 6=NG mod 6 for inband-DifferentPCI mode deployment.

3GPP TS 36.211
6.10.1.2 Mapping to resource elements
<Omitted>
The cell-specific frequency shift is given by v_{shift} = N_{ID}^{Cell} mod 6.
<Omitted>
10.2.4.4 Mapping to resource elements
<Omitted>
For the purpose of the mapping, the UE shall assume cell-specific
reference signals for antenna ports 0-3 and narrowband reference signals
for antenna ports 2000 and 2001 being present irrespective of the actual
configuration. The frequency shift of the cell-specific reference signals
shall be calculated by replacing N_{ID}^{cell} with N_{ID}^{Ncell} in the calculation of
v_{shift} in clause 6.10.1.2.

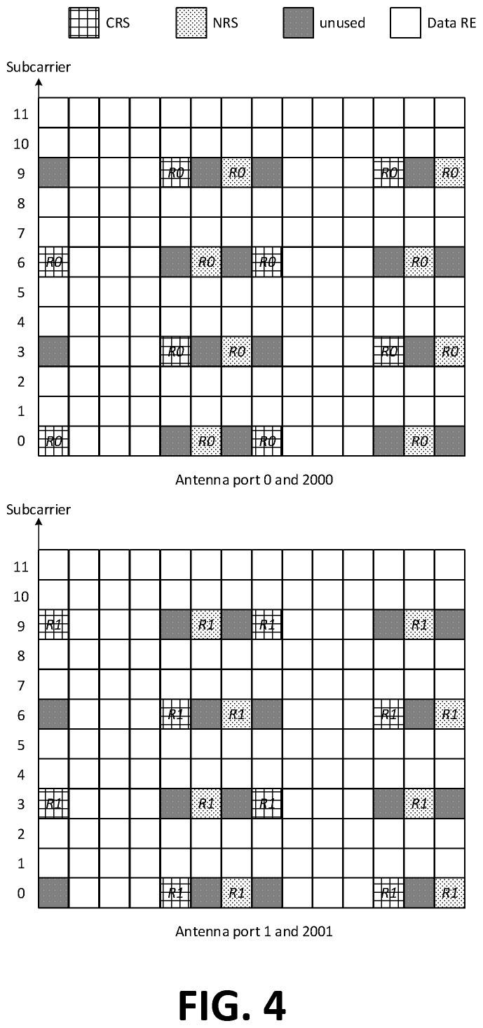

FIG. 4 is a diagram illustrating exemplary CRS and NRS positions in resource grids in an in-band deployment mode. FIG. 4 shows the CRS on port 0 and 1 and NRS on port 2000 and 2001. As shown in FIG. 4, a UE assumes for the in-band mode that CRS and NRS need to be located on the same subcarrier.

Therefore, in the current 3GPP definition, there is not enough bandwidth for an NB-IoT carrier to be deployed in an LTE carrier with a bandwidth of 3 MHz and/or 5 MHz in the guard-band mode. Further, an NB-IoT carrier cannot be deployed in the in-band mode on the edge PRB of an LTE carrier with a bandwidth of 3 MHz and/or 5 MHz since it is not on the 100 kHz raster, that is, PRB 0 or PRB 14 for LTE 3 MHz bandwidth, and PRB 0 or PRB 24 for LTE 5 MHz bandwidth.

In some embodiments, a modified version of NB-IoT inband-DifferentPCI mode may be used to deploy an NB-IoT carrier in an LTE carrier with a narrow bandwidth, for example, by partially overlapping with LTE guard-band and an edge PRB of LTE 3 MHz or 5 MHz bandwidth.

In some embodiments, a solution to allocate an NB-IoT downlink anchor carrier by partially overlapping with LTE guard-band and an edge PRB of 3 MHz or 5 MHz host LTE bandwidth may be provided, and the inband-DifferentPCI mode may be used.

In some embodiments, a PCI allocation algorithm for the NB-IoT cell with relationship to the PCI of the host LTE cell may be provided accordingly to avoid resource conflicting with LTE CRS.

With some embodiments of the present disclosure, the flexibility and possibility to deploy NB-IoT anchor carrier in LTE 3 MHz or 5 MHz bandwidth may be improved, for example, by partial overlapping with LTE quard-band and an edge PRB of LTE 3 MHz or 5 MHz bandwidth. Further, such a solution is compatible with all legacy NB-IoT UEs and 3GPP specification change is needed. Furthermore, only 1 PRB is occupied from the host LTE carrier if the NB-IoT carrier is on the upper side edge with above partially overlap with LTE guard-band, and therefore more resources can be left for LTE type 0 resource allocation.

In some embodiments, a solution to deploy NB-IoT downlink carrier which does not align with PRB boundary of LTE 3 MHz or 5 MHz bandwidth is introduced, and an NB-IoT anchor carrier may be partially allocated in an guard-band and partially in an edge PRB.

With the inband-DifferentPCI mode indicated in the MIB-NB, a UE does not need to be aware of this partial overlapping with LTE guard-band, and the UE may treat this as the normal in-band mode and will assume the CRS exist in all the possible positions described in 3GPP TS 36.211 as described with reference to FIG. 4. Further, some embodiments of the present disclosure may also provide a PCI allocation algorithm for the NB-IoT cell with relationship to the PCI of the host LTE cell accordingly to avoid resource collision with LTE CRS.

### Allocates the NB-IoT Downlink Carrier on Host LTE Bandwidth of 3 MHz

FIG. 5 is a diagram illustrating an exemplary deployment in which an NB-IoT carrier is deployed partially overlapped with a guard-band of a 3 MHz LTE carrier according to an embodiment of the present disclosure. As defined in 3GPP, an LTE carrier with a bandwidth of 3 MHz may comprise totally 15 PRBs (indicated by PRB 0 through PRB 14), or comprise 7 RBGs with an RBG size of 2 (indicated by RBG 0 through RBG 6) and 1 RBG with an RBG size of 1 (indicated by RBG 7), so totally 8 RBGs. The LTE DC carrier which is located exactly on 100 kHz raster is in the center of the PRB 7, and the guard-band is 142.5 kHz on each side as show in FIG. 5.

The distance from the center of an edge PRB (e.g., the PRB 0 or the PRB 14) to the LTE DC carrier is 1267.5 kHz, and it is not on the 100 kHz raster with raster offset of {±2.5 kHz, ±7.5 kHz}. In some embodiments, by partially overlapping with LTE guard-band, the NB-IoT carrier can be moved to the closest raster, such that the NB-IoT carrier can be located on the 100 kHz raster with an allowed raster offset and orthogonality can be kept in a subcarrier level. Further, in some embodiments, the operationMode needs to be set to inband-DifferentPCI since CRS is not always available on all the NB-IoT subcarriers. However, the present disclosure is not limited thereto. In some other embodiments, the operationMode may be set to another mode, for example, a new mode that is not currently defined in any of the 3GPP technical specifications. Furthermore, the rest of the guard-band is wide enough from a filter design point of view to fulfill the 3GPP RAN4 radio transmission requirements.

In the embodiment shown in FIG. 5, when the NB-IoT downlink anchor carrier is deployed on the lower side of the 3 MHz LTE bandwidth, it may have 2 subcarriers overlapped with the LTE guard-band on the lower side, and the other 10 subcarriers may be located in or overlapped with the PRB 0. In such a case, the rest of the guard-band on the lower side is 112.5 kHz, and the operationModeInfo-r13 may be set to inband-DifferentPCI with a ChannelRasterOffset-NB-r13 of KHz2dot5.

In the embodiment shown in FIG. 5, when the NB-IoT downlink anchor carrier is deployed on the upper side of the 3 MHz LTE bandwidth, it may have 2 subcarriers overlapped with the LTE guard-band on the upper side, and the other 10 subcarriers may be located in or overlapped with the PRB 14. In such a case, the rest of the guard-band on the upper side is 112.5 kHz, and the operationModeInfo-r13 may be set to inband-DifferentPCI with a ChannelRasterOffset-NB-r13 of kHz-2dot5. Further, in this embodiment, when the type 0 resource allocation with RBG granularity is used on the LTE carrier, only one PRB from the LTE bandwidth needs to be occupied by the NB-IoT carrier.

### Allocates the NB-IoT Downlink Carrier on Host LTE Bandwidth of 5 MHz

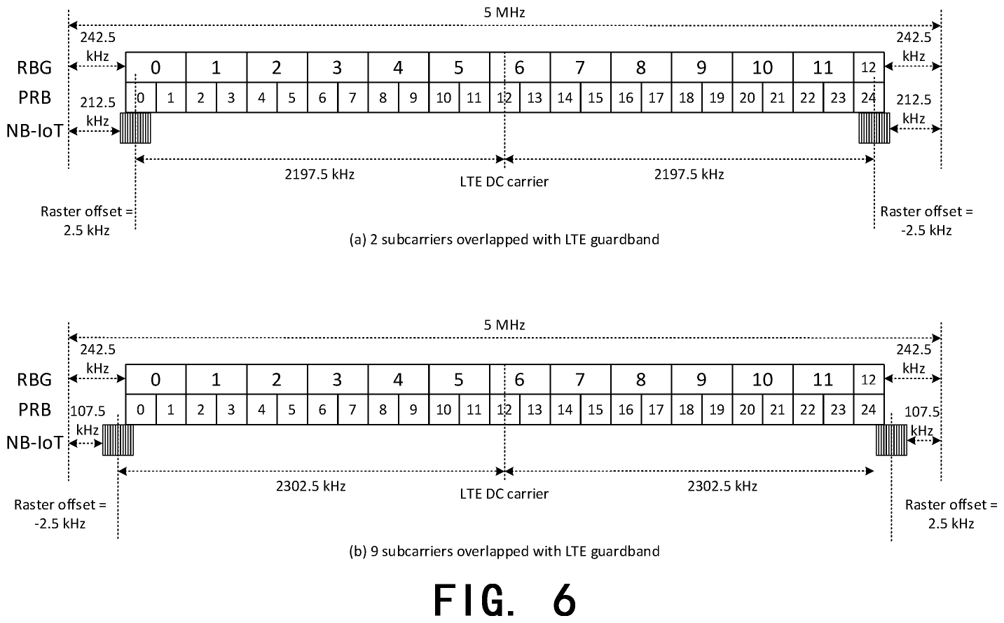

FIG. 6 is a diagram illustrating exemplary deployments in each of which an NB-IoT carrier is deployed partially overlapped with a guard-band of a 5 MHz LTE carrier according to some embodiments of the present disclosure. As defined in 3GPP, an LTE carrier with a bandwidth of 5 MHz may comprise totally 25 PRBs (indicated by PRB 0 through PRB 24), or comprise 12 RBGs with an RBG size of 2 (indicated by RBG 0 through RBG 11) and 1 RBG with an RBG size of 1 (indicated by RBG 12), so totally 13 RBGs. The LTE DC carrier which is located exactly on 100 kHz raster is in the center of the PRB 12, and the guard-band is 242.5 kHz on each side as show in FIG. 6.

The distance from the center of an edge PRB (e.g., the PRB 0 or the PRB 24) to the LTE DC carrier is 2167.5 kHz, and it is not on the 100 kHz raster with raster offset of {±2.5 kHz, ±7.5 kHz}. In some embodiments, by partially overlapping with LTE guard-band, the NB-IoT carrier can be moved to the closest raster, such that the NB-IoT carrier can be located on the 100 kHz raster with an allowed raster offset and orthogonality can be kept in a subcarrier level. Further, in some embodiments, the operationMode needs to be set to inband-DifferentPCI since CRS is not always available on all the NB-IoT subcarriers. However, the present disclosure is not limited thereto. In some other embodiments, the operationMode may be set to another mode, for example, a new mode that is not currently defined in any of the 3GPP technical specifications. Furthermore, the rest of the guard-band is wide enough from a filter design point of view to fulfill the 3GPP RAN4 radio transmission requirements.

In the embodiment shown in (a) of FIG. 6, when the NB-IoT downlink anchor carrier is deployed on the lower side of the 5 MHz LTE bandwidth, it may have 2 subcarriers overlapped with the LTE guard-band on the lower side, and the other 10 subcarriers may be located in or overlapped with the PRB 0. In such a case, the rest of the guard-band on the lower side is 212.5 kHz, and the operationModeInfo-r13 may be set to inband-DifferentPCI with a ChannelRasterOffset-NB-r13 of KHz2dot5.

In the embodiment shown in (a) of FIG. 6, when the NB-IoT downlink anchor carrier is deployed on the upper side of the 5 MHz LTE bandwidth, it may have 2 subcarriers overlapped with the LTE guard-band on the upper side, and the other 10 subcarriers may be located in or overlapped with the PRB 24. In such a case, the rest of the guard-band on the upper side is 212.5 kHz, and the operationModeInfo-r13 may be set to inband-DifferentPCI with a ChannelRasterOffset-NB-r13 of kHz-2dot5. Further, in this embodiment, when the type 0 resource allocation with RBG granularity is used on the LTE carrier, only one PRB from the LTE bandwidth needs to be occupied by the NB-IoT carrier.

In the embodiment shown in (b) of FIG. 6, when the NB-IoT downlink anchor carrier is deployed on the lower side of the 5 MHz LTE bandwidth, it may have 9 subcarriers overlapped with the LTE guard-band on the lower side, and the other 3 subcarriers may be located in or overlapped with the PRB 0. In such a case, the rest of the guard-band on the lower side is 107.5 kHz, and the operationModeInfo-r13 may be set to inband-DifferentPCI with a ChannelRasterOffset-NB-r13 of kHz-2dot5.

In the embodiment shown in (b) of FIG. 6, when the NB-IoT downlink anchor carrier is deployed on the upper side of the 5 MHz LTE bandwidth, it may have 9 subcarriers overlapped with the LTE guard-band on the upper side, and the other 3 subcarriers may be located in or overlapped with the PRB 24. In such a case, the rest of the guard-band on the upper side is 107.5 kHz, and the operationModeInfo-r13 may be set to inband-DifferentPCI with a ChannelRasterOffset-NB-r13 of kHz2dot5. Further, in this embodiment, when the type 0 resource allocation with RBG granularity is used on the LTE carrier, only one PRB from the LTE bandwidth needs to be occupied by the NB-IoT carrier.

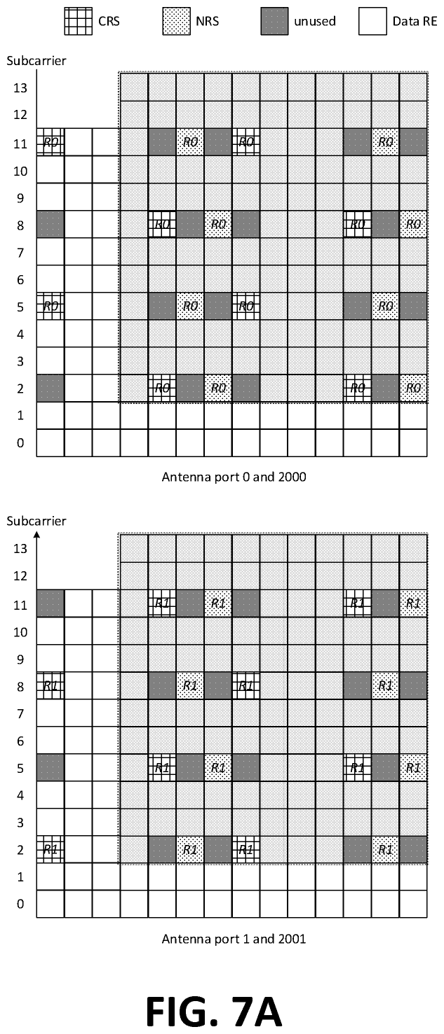

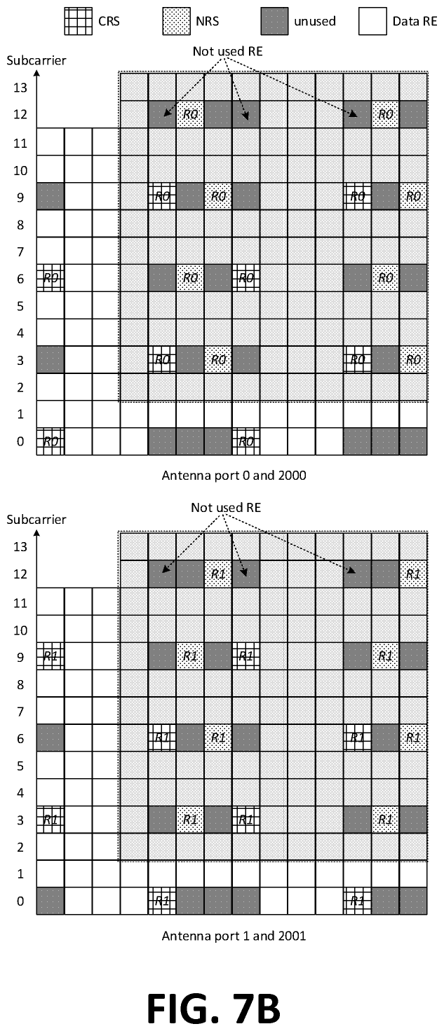

Next, an NB-IoT PCI allocation algorithm and Resource Element mapping will be described with reference to FIG. 7. The non-alignment with LTE PRB boundary will lead to changed relative positions of NB-IoT NRSs with respect to LTE CRSs, and therefore a PCI offset is needed for an NB-IoT cell to make sure that the CRS and NRS are located on the same subcarriers and interference can be avoided.

The NB-IoT PCI allocation based on LTE host cell PCI for different CRS antenna ports are listed in Table 2.

TABLE 2
NB-IoT PCI allocation

| | | Number of | | | | |
|---|---|---|---|---|---|---|
| | | subcarriers | | | | |
| | | overlapped | Residual | Channel | | |
| LTE | PRB | with LTE | subcarriers in | Raster | NB-IoT PCI allocation | NB-IoT PCI allocation |
| Bandwidth | index | guard-band | LTE PRB | Offset | for 1 CRS port | for 2 or 4 CRS ports |
| 3 MHz | 0 | 2 | 10 | kHz2dot5 | N_{ID}^{Ncell} mod 6 == (N_{ID}^{Cell} + 2) mod 6 | N_{ID}^{Ncell} mod 3 == (N_{ID}^{Cell} + 2) mod 3 |
| 3 MHz | 14 | 2 | 10 | kHz-2dot5 | N_{ID}^{Ncell} mod 6 == (N_{ID}^{Cell} − 2) mod 6 | N_{ID}^{Ncell} mod 3 == (N_{ID}^{Cell} − 2) mod 3 |
| 5 MHz | 0 | 2 | 10 | kHz2dot5 | N_{ID}^{Ncell} mod 6 == (N_{ID}^{Cell} + 2) mod 6 | N_{ID}^{Ncell} mod 3 == (N_{ID}^{Cell} + 2) mod 3 |
| 5 MHz | 24 | 2 | 10 | kHz-2dot5 | N_{ID}^{Ncell} mod 6 == (N_{ID}^{Cell} − 2) mod 6 | N_{ID}^{Ncell} mod 3 == (N_{ID}^{Cell} − 2) mod 3 |
| 5 MHz | 0 | 9 | 3 | kHz-2dot5 | N_{ID}^{Ncell} mod 6 == (N_{ID}^{Cell} + 3) mod 6 | N_{ID}^{Ncell} mod 3 == N_{ID}^{Cell} mod 3 |
| 5 MHz | 24 | 9 | 3 | kHz2dot5 | N_{ID}^{Ncell} mod 6 == (N_{ID}^{Cell} − 3) mod 6 | N_{ID}^{Ncell} mod 3 == N_{ID}^{Cell} mod 3 |

In some embodiments, the starting Orthogonal Frequency Division Multiplexing (OFDM) symbol for NPDSCH and/or NPDCCH is given by index l_{DataStart} and/or l_{NPDCCHStart} respectively. For the in-band mode, it is given by eutraControlRegionSize which reserves resources for LTE control channels. In some embodiments, the subcarriers of the NB-IoT carrier that are overlapped with the LTE guard-band may also follow the same configuration of the subcarriers of the NB-IoT carrier that are located in-band or overlapped with the LTE transmission bandwidth.

FIG. 7A and FIG. 7B are diagrams illustrating exemplary CRS and NRS positions in resource grids in a deployment mode according to some embodiments of the present disclosure. FIG. 7A shows CRS and NRS positions when they are not located in the subcarriers overlapped with the guard-band of the LTE carrier, while FIG. 7B shows CRS and NRS positions when at least some of them are located in the subcarriers overlapped with the guard-band of the LTE carrier.

For the CRS/NRS configuration shown in FIG. 7A, the resource mapping may be similar to that shown in FIG. 4 since none of the NRSs is located in the subcarriers overlapped with the guard-band (e.g., the subcarriers 12 and 13 shown in FIG. 7A).

However, in case of some of the NRSs exist in the subcarriers overlapped with the LTE guard-band (e.g., the subcarriers 12 and 13 shown in FIG. 7B), then the CRS symbols on the same subcarrier also need to be reserved without sending any data, so UE can follow the legacy mapping rule of inband-DifferentPCI to skip the possible CRS positions even there is no CRS send at all from the eNB. As shown in FIG. 7A and FIG. 7B, the REs on the first 3 symbols are reserved for LTE control channels when eutraControlRegionSize is set to 3, and the NB-IoT carrier is deployed on the upper edge of either 3 MHz or 5 MHz LTE bandwidth with 2 subcarriers overlapped with LTE guard-band. Further, some of the NRSs are located on the subcarrier 12 which is overlapped with the LTE guard-band. On the same subcarrier 12, there are 3 additional REs on the symbol 4, 7, and 11 which are CRS symbols should also be skipped when NB-IoT downlink data mapping is performed.

With such a deployment, a UE (e.g., a legacy NB-IoT UE) does not need to be aware of this partial overlapping with LTE guard-band, and the UE may treat this as the normal in-band mode and will assume the CRS exist in all the possible positions. Further, with such a deployment, frequency spectrum can be utilized in a more efficient manner.

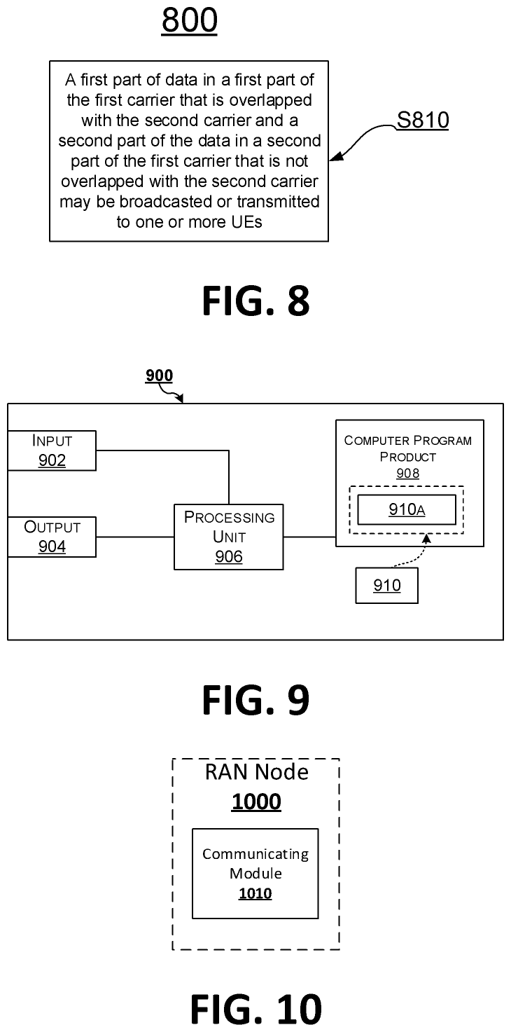

FIG. 8 is a flow chart of an exemplary method 800 at a RAN node for serving a first cell with a first carrier that is partially overlapped with a second carrier of a second cell according to an embodiment of the present disclosure. The method 800 may be performed at a RAN node (e.g., the eNB 105). The method 800 may comprise a step S810. However, the present disclosure is not limited thereto. In some other embodiments, the method 800 may comprise more steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where a first part of data in a first part of the first carrier that is overlapped with the second carrier and a second part of the data in a second part of the first carrier that is not overlapped with the second carrier may be broadcasted or transmitted to one or more UEs.

In some embodiments, the first carrier may be an anchor carrier of the first cell. In some embodiments, the second carrier may have a bandwidth of 3 MHz, 5 MHz, 10 MHz, 15 MHz, or 20 MHz.

In some embodiments, when the second carrier has a bandwidth of 3 MHz, the first part of the first carrier may have 10 subcarriers while the second part of the first carrier may have 2 subcarriers that are overlapped with a guard-band associated with the second carrier. In some embodiments, when the second carrier has a bandwidth of 3 MHz, at least one of following may be true: with type 0 resource allocation for the second carrier, an RBG comprising 2 PRBs on the lower side of the second carrier cannot be scheduled for the second carrier when the first carrier is on the lower side of the second carrier; and with type 0 resource allocation for the second carrier, an RBG comprising 1 PRB on the upper side of the second carrier cannot be scheduled for the second carrier when the first carrier is on the upper side of the second carrier. In some embodiments, when the second carrier has a bandwidth of 3 MHz, at least one of following may be true: broadcasting a message indicating that a channel raster offset of 2.5 kHz is to be applied at any UE to access the first carrier when the first carrier is on the lower side of the second carrier; and broadcasting a message indicating that a channel raster offset of −2.5 kHz is to be applied at any UE to access the first carrier when the first carrier is on the upper side of the second carrier.

In some embodiments, when the second carrier has a bandwidth of 5 MHz, at least one of following may be true: the first part of the first carrier has 10 subcarriers while the second part of the first carrier has 2 subcarriers that are overlapped with a guard-band associated with the second carrier; and the first part of the first carrier has 3 subcarriers while the second part of the first carrier has 9 subcarriers that are overlapped with a guard-band associated with the second carrier. In some embodiments, the second carrier has a bandwidth of 5 MHz, at least one of following may be true: with type 0 resource allocation for the second carrier, an RBG comprising 2 PRBs on the lower side of the second carrier cannot be scheduled for the second carrier when the first carrier is on the lower side of the second carrier; and with type 0 resource allocation for the second carrier, an RBG comprising 1 PRB on the upper side of the second carrier cannot be scheduled for the second carrier when the first carrier is on the upper side of the second carrier. In some embodiments, when the second carrier has a bandwidth of 5 MHz, at least one of following may be true: broadcasting a message indicating that a channel raster offset of 2.5 kHz is to be applied at any UE to access the first carrier when the first carrier is on the lower side of the second carrier and has 2 subcarriers overlapped with a guard-band associated with the second carrier; broadcasting a message indicating that a channel raster offset of −2.5 kHz is to be applied at any UE to access the first carrier when the first carrier is on the upper side of the second carrier and has 2 subcarriers overlapped with a guard-band associated with the second carrier; broadcasting a message indicating that a channel raster offset of −2.5 kHz is to be applied at any UE to access the first carrier when the first carrier is on the lower side of the second carrier and has 9 subcarriers overlapped with a guard-band associated with the second carrier; and broadcasting a message indicating that a channel raster offset of 2.5 kHz is to be applied at any UE to access the first carrier when the first carrier is on the upper side of the second carrier and has 9 subcarriers overlapped with a guard-band associated with the second carrier.

In some embodiments, the method 800 may further comprise: broadcasting a message indicating that the first carrier has an operation mode of “inband-DifferentPCI” with respect to the second carrier. In some embodiments, at least one of following may be true: N_{ID}^{Ncell} mod 6=(N_{ID}^{Cell}+2) mod 6 when the second carrier has a bandwidth of 3 MHz, the first carrier is on the lower side of the second carrier and has 2 subcarriers overlapped with a guard-band associated with the second carrier, and 1 Cell-specific Reference Signal (CRS) port is configured for the second carrier; N_{ID}^{Ncell} mod 6=(N_{ID}^{Cell}−2) mod 6 when the second carrier has a bandwidth of 3 MHz, the first carrier is on the upper side of the second carrier and has 2 subcarriers overlapped with a guard-band associated with the second carrier, and 1 CRS port is configured for the second carrier; N_{ID}^{Ncell} mod 3=(N_{ID}^{Cell}+2) mod 3 when the second carrier has a bandwidth of 3 MHz, the first carrier is on the lower side of the second carrier and has 2 subcarriers overlapped with a guard-band associated with the second carrier, and 2 or 4 CRS ports are configured for the second carrier; N_{ID}^{Ncell} mod 3=(N_{ID}^{Cell}−2) mod 3 when the second carrier has a bandwidth of 3 MHz, the first carrier is on the upper side of the second carrier and has 2 subcarriers overlapped with a guard-band associated with the second carrier, and 2 or 4 CRS ports are configured for the second carrier; N_{ID}^{Ncell} mod 6=(N_{ID}^{Cell}+2) mod 6 when the second carrier has a bandwidth of 5 MHz, the first carrier is on the lower side of the second carrier and has 2 subcarriers overlapped with a guard-band associated with the second carrier, and 1 CRS port is configured for the second carrier; N_{ID}^{Ncell} mod 6=(N_{ID}^{Cell}−2) mod 6 when the second carrier has a bandwidth of 5 MHz, the first carrier is on the upper side of the second carrier and has 2 subcarriers overlapped with a guard-band associated with the second carrier, and 1 CRS port is configured for the second carrier; N_{ID}^{Cell} mod 3=(N_{ID}^{Cell}+2) mod 3 when the second carrier has a bandwidth of 5 MHz, the first carrier is on the lower side of the second carrier and has 2 subcarriers overlapped with a guard-band associated with the second carrier, and 2 or 4 CRS ports are configured for the second carrier; N_{ID}^{Ncell} mod 3=(N_{ID}^{Cell}−2) mod 3 when the second carrier has a bandwidth of 5 MHz, the first carrier is on the upper side of the second carrier and has 2 subcarriers overlapped with a guard-band associated with the second carrier, and 2 or 4 CRS ports are configured for the second carrier; N_{ID}^{Ncell} mod 6=(N_{ID}^{Cell}+3) mod 6 when the second carrier has a bandwidth of 5 MHz, the first carrier is on the lower side of the second carrier and has 9 subcarriers overlapped with a guard-band associated with the second carrier, and 1 CRS port is configured for the second carrier; N_{ID}^{Ncell} mod 6=(N_{ID}^{Cell}−3) mod 6 when the second carrier has a bandwidth of 5 MHz, the first carrier is on the upper side of the second carrier and has 9 subcarriers overlapped with a guard-band associated with the second carrier, and 1 CRS port is configured for the second carrier; N_{ID}^{Ncell} mod 3=N_{ID}^{Cell} mod 3 when the second carrier has a bandwidth of 5 MHz, the first carrier is on the lower side of the second carrier and has 9 subcarriers overlapped with a guard-band associated with the second carrier, and 2 or 4 CRS ports are configured for the second carrier; N_{ID}^{Ncell} mod3=N_{ID}^{Cell} mod 3 when the second carrier has a bandwidth of 5 MHz, the first carrier is on the upper side of the second carrier and has 9 subcarriers overlapped with a guard-band associated with the second carrier, and 2 or 4 CRS ports are configured for the second carrier, wherein N_{ID}^{Ncell} refers to the PCI of the first cell and N_{ID}^{Cell} refers to the PCI of the second cell.

In some embodiments, the starting symbol for NPDSCH and/or NPDCCH in the subcarriers of the second part of the first carrier may be same as that in the subcarriers of the first part of the first carrier. In some embodiments, one or more REs in the first carrier may be reserved for CRS transmission associated with the second carrier. In some embodiments, the one or more reserved REs may comprise at least one RE in the second part of the first carrier. In some embodiments, the one or more reserved REs comprise no RE in the second part of the first carrier. In some embodiments, the data may comprise one or more NRS at least. In some embodiments, the first carrier may be an NB-IoT carrier and the second carrier may be an E-UTRA carrier. In some embodiments, the second cell may also be served by the RAN node.

FIG. 9 schematically shows an embodiment of an arrangement 900 which may be used in a RAN node (e.g., the eNB 105) according to an embodiment of the present disclosure. Comprised in the arrangement 900 are a processing unit 906, e.g., with a Digital Signal Processor (DSP) or a Central Processing Unit (CPU). The processing unit 906 may be a single unit or a plurality of units to perform different actions of procedures described herein. The arrangement 900 may also comprise an input unit 902 for receiving signals from other entities, and an output unit 904 for providing signal(s) to other entities. The input unit 902 and the output unit 904 may be arranged as an integrated entity or as separate entities.

Furthermore, the arrangement 900 may comprise at least one computer program product 908 in the form of a non-volatile or volatile memory, e.g., an Electrically Erasable Programmable Read-Only Memory (EEPROM), a flash memory and/or a hard drive. The computer program product 908 comprises a computer program 910, which comprises code/computer readable instructions, which when executed by the processing unit 906 in the arrangement 900 causes the arrangement 900 and/or the RAN node in which it is comprised to perform the actions, e.g., of the procedure described earlier in conjunction with FIG. 8 or any other variant.

The computer program 910 may be configured as a computer program code structured in a computer program module 910A. Hence, in an exemplifying embodiment when the arrangement 900 is used in a RAN node, the code in the computer program of the arrangement 900 includes: a module 910A configured to broadcast or transmit, to one or more UEs, a first part of data in a first part of the first carrier that is overlapped with the second carrier and a second part of the data in a second part of the first carrier that is not overlapped with the second carrier.

The computer program modules could essentially perform the actions of the flow illustrated in FIG. 8, to emulate the RAN node. In other words, when the different computer program modules are executed in the processing unit 906, they may correspond to different modules in the RAN node.

Although the code means in the embodiments disclosed above in conjunction with FIG. 9 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

Correspondingly to the method 800 as described above, an exemplary RAN node is provided. FIG. 10 is a block diagram of a RAN node 1000 according to an embodiment of the present disclosure. The RAN node 1000 may be, e.g., the eNB 105 in some embodiments.

The RAN node 1000 may be configured to perform the method 800 as described above in connection with FIG. 8. As shown in FIG. 10, the RAN node 1000 may comprise a communicating module 1010 configured to broadcast or transmit, to one or more UEs, a first part of data in a first part of the first carrier that is overlapped with the second carrier and a second part of the data in a second part of the first carrier that is not overlapped with the second carrier.

The above module 1010 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the RAN node 1000 may comprise one or more further modules, each of which may perform any of the steps of the method 800 described with reference to FIG. 8.

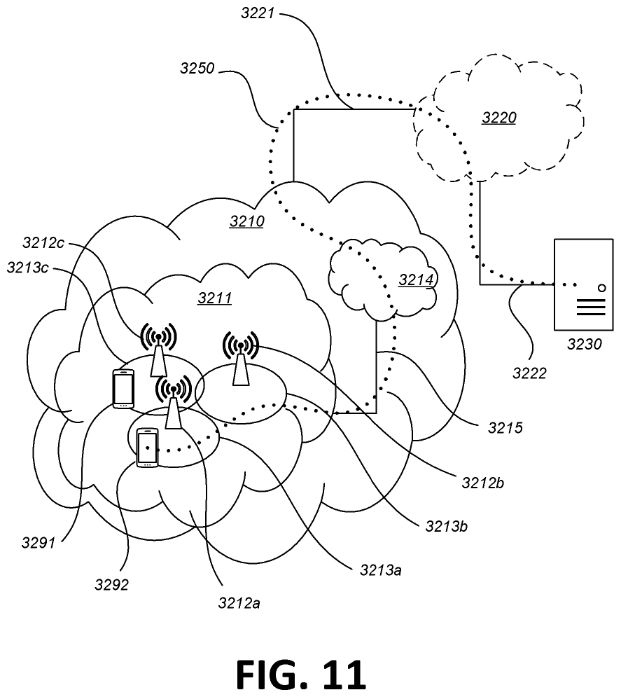

With reference to FIG. 11, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private, or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

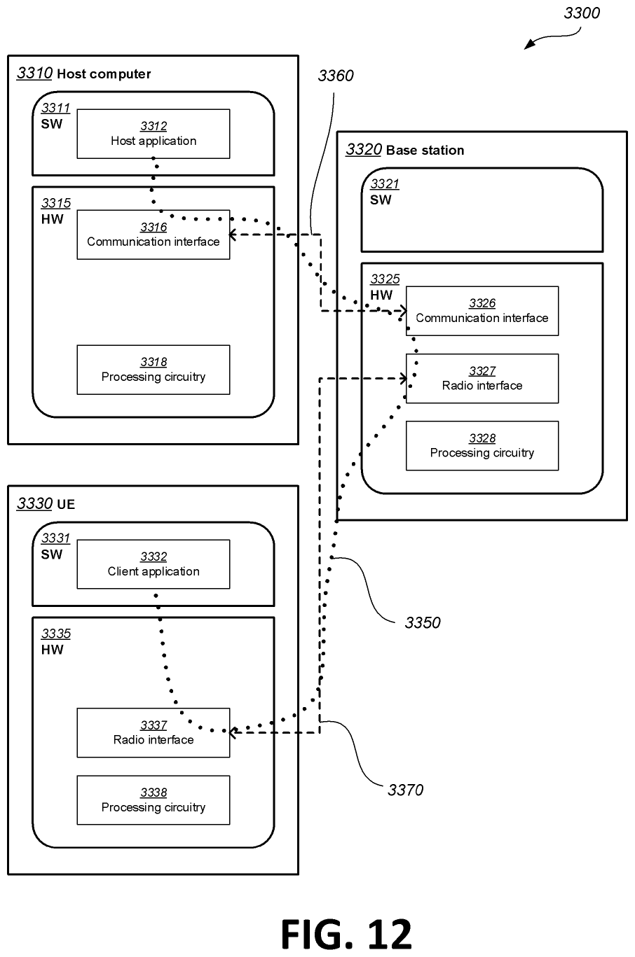

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

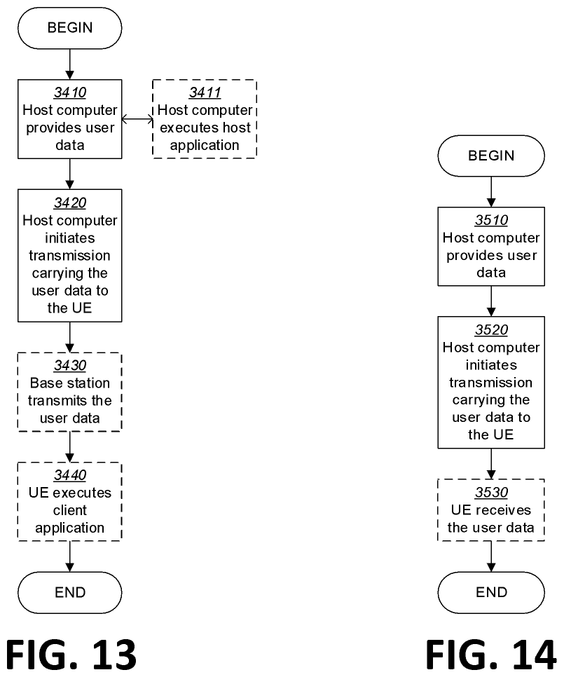

FIG. 13 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 13 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 14 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

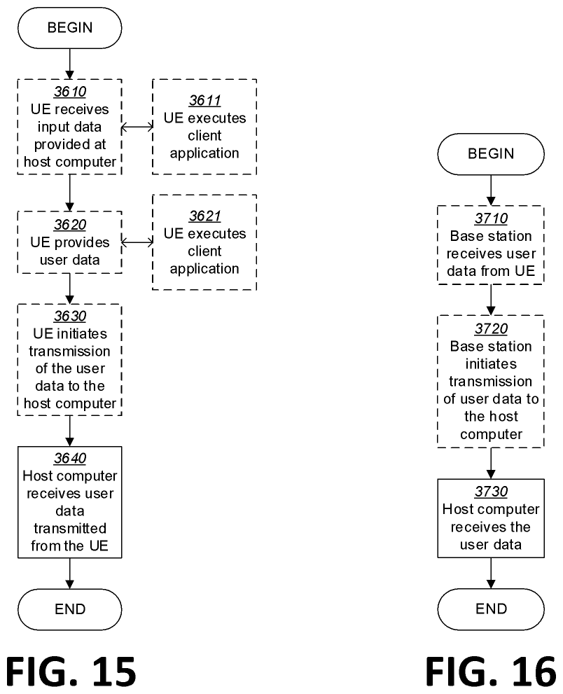

FIG. 15 is a flowchart illustrating a method implemented in a communication system, in accordance with one embodiment. The communication system includes a host computer, a base station and a UE which may be those described with reference to FIG. 11 and FIG. 12. For simplicity of the present disclosure, only drawing references to FIG. 15 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| CRS | Cell-specific Reference Signal |
| LTE | Long Term Evolution |
| N_{ID}^{Cell} | LTE Physical Cell Identity |
| N_{ID}^{NCell} | NB-IoT Physical Cell Identity |
| NB-IoT | Narrowband Internet of Thing |
| NRS | NB-IoT Reference Signal |
| PCI | Physical Cell Identity |

1. A method at a Radio Access Network (RAN) node for serving a first cell with a first carrier that is partially overlapped with a second carrier of a second cell, the method comprising:
broadcasting or transmitting, to one or more User Equipments (UEs), a first part of data in a first part of the first carrier that is overlapped with the second carrier and a second part of the data in a second part of the first carrier that is not overlapped with the second carrier.

2. The method of claim 1, wherein the first carrier is an anchor carrier of the first cell.

3. The method of claim 1, wherein the second carrier has a bandwidth of 3 MHz, 5 MHz, 10 MHz, 15 MHz, or 20 MHz.

4. The method of claim 1, wherein when the second carrier has a bandwidth of 3 MHz, the first part of the first carrier has 10 subcarriers while the second part of the first carrier has 2 subcarriers that are overlapped with a guard-band associated with the second carrier.

5. The method of claim 1, wherein when the second carrier has a bandwidth of 3 MHz, at least one of following is true:
with type 0 resource allocation for the second carrier, a resource block group (RBG) comprising 2 physical resource blocks (PRBs) on the lower side of the second carrier cannot be scheduled for the second carrier when the first carrier is on the lower side of the second carrier; and
with type 0 resource allocation for the second carrier, an RBG comprising 1 PRB on the upper side of the second carrier cannot be scheduled for the second carrier when the first carrier is on the upper side of the second carrier.

6. The method of claim 1, wherein when the second carrier has a bandwidth of 3 MHz, at least one of following is true:
broadcasting a message indicating that a channel raster offset of 2.5 kHz is to be applied at any UE to access the first carrier when the first carrier is on the lower side of the second carrier; and
broadcasting a message indicating that a channel raster offset of −2.5 kHz is to be applied at any UE to access the first carrier when the first carrier is on the upper side of the second carrier.

7. The method of claim 1 wherein when the second carrier has a bandwidth of 5 MHz, at least one of following is true:
the first part of the first carrier has 10 subcarriers while the second part of the first carrier has 2 subcarriers that are overlapped with a guard-band associated with the second carrier; and
the first part of the first carrier has 3 subcarriers while the second part of the first carrier has 9 subcarriers that are overlapped with a guard-band associated with the second carrier.

8. The method of claim 1, wherein when the second carrier has a bandwidth of 5 MHz, at least one of following is true:
with type 0 resource allocation for the second carrier, an RBG comprising 2 PRBs on the lower side of the second carrier cannot be scheduled for the second carrier when the first carrier is on the lower side of the second carrier; and
with type 0 resource allocation for the second carrier, an RBG comprising 1 PRB on the upper side of the second carrier cannot be scheduled for the second carrier when the first carrier is on the upper side of the second carrier.

9. The method of claim 1, wherein when the second carrier has a bandwidth of 5 MHz, at least one of following is true:
broadcasting a message indicating that a channel raster offset of 2.5 kHz is to be applied at any UE to access the first carrier when the first carrier is on the lower side of the second carrier and has 2 subcarriers overlapped with a guard-band associated with the second carrier;
broadcasting a message indicating that a channel raster offset of −2.5 kHz is to be applied at any UE to access the first carrier when the first carrier is on the upper side of the second carrier and has 2 subcarriers overlapped with a guard-band associated with the second carrier;
broadcasting a message indicating that a channel raster offset of −2.5 kHz is to be applied at any UE to access the first carrier when the first carrier is on the lower side of the second carrier and has 9 subcarriers overlapped with a guard-band associated with the second carrier; and
broadcasting a message indicating that a channel raster offset of 2.5 kHz is to be applied at any UE to access the first carrier when the first carrier is on the upper side of the second carrier and has 9 subcarriers overlapped with a guard-band associated with the second carrier.

10. The method of claim 1, further comprising:
broadcasting a message indicating that the first carrier has an operation mode of “inband-DifferentPCI” with respect to the second carrier.

11. The method of claim 1, wherein at least one of following is true:
N_{ID}^{Ncell} mod 6=(N_{ID}^{Cell}+2) mod 6 when the second carrier has a bandwidth of 3 MHz, the first carrier is on the lower side of the second carrier and has 2 subcarriers overlapped with a guard-band associated with the second carrier, and 1 Cell-specific Reference Signal (CRS) port is configured for the second carrier;
N_{ID}^{Ncell} mod 6=(N_{ID}^{Cell}−2) mod 6 when the second carrier has a bandwidth of 3 MHz, the first carrier is on the upper side of the second carrier and has 2 subcarriers overlapped with a guard-band associated with the second carrier, and 1 CRS port is configured for the second carrier;
N_{ID}^{Ncell} mod 3=(N_{ID}^{Cell}+2) mod 3 when the second carrier has a bandwidth of 3 MHz, the first carrier is on the lower side of the second carrier and has 2 subcarriers overlapped with a guard-band associated with the second carrier, and 2 or 4 CRS ports are configured for the second carrier;
N_{ID}^{Ncell} mod 3=(N_{ID}^{Cell}−2) mod 3 when the second carrier has a bandwidth of 3 MHz, the first carrier is on the upper side of the second carrier and has 2 subcarriers overlapped with a guard-band associated with the second carrier, and 2 or 4 CRS ports are configured for the second carrier;
N_{ID}^{Ncell} mod 6=(N_{ID}^{Cell}+2) mod 6 when the second carrier has a bandwidth of 5 MHz, the first carrier is on the lower side of the second carrier and has 2 subcarriers overlapped with a guard-band associated with the second carrier, and 1 CRS port is configured for the second carrier;
N_{ID}^{Ncell} mod 6=(N_{ID}^{Cell}−2) mod 6 when the second carrier has a bandwidth of 5 MHz, the first carrier is on the upper side of the second carrier and has 2 subcarriers overlapped with a guard-band associated with the second carrier, and 1 CRS port is configured for the second carrier;
N_{ID}^{Ncell} mod 3=(N_{ID}^{Cell}+2) mod 3 when the second carrier has a bandwidth of 5 MHz, the first carrier is on the lower side of the second carrier and has 2 subcarriers overlapped with a guard-band associated with the second carrier, and 2 or 4 CRS ports are configured for the second carrier;
N_{ID}^{Ncell} mod 3=(N_{ID}^{Cell}−2) mod 3 when the second carrier has a bandwidth of 5 MHz, the first carrier is on the upper side of the second carrier and has 2 subcarriers overlapped with a guard-band associated with the second carrier, and 2 or 4 CRS ports are configured for the second carrier;
N_{ID}^{Ncell} mod 6=(N_{ID}^{Cell}+3) mod 6 when the second carrier has a bandwidth of 5 MHz, the first carrier is on the lower side of the second carrier and has 9 subcarriers overlapped with a guard-band associated with the second carrier, and 1 CRS port is configured for the second carrier;
N_{ID}^{Ncell} mod 6=(N_{ID}^{Cell}−3) mod 6 when the second carrier has a bandwidth of 5 MHz, the first carrier is on the upper side of the second carrier and has 9 subcarriers overlapped with a guard-band associated with the second carrier, and 1 CRS port is configured for the second carrier;
N_{ID}^{Ncell} mod 3=N_{ID}^{Cell} mod 3 when the second carrier has a bandwidth of 5 MHz, the first carrier is on the lower side of the second carrier and has 9 subcarriers overlapped with a guard-band associated with the second carrier, and 2 or 4 CRS ports are configured for the second carrier; and
N_{ID}^{Ncell} mod 3=N_{ID}^{Cell} mod 3 when the second carrier has a bandwidth of 5 MHz, the first carrier is on the upper side of the second carrier and has 9 subcarriers overlapped with a guard-band associated with the second carrier, and 2 or 4 CRS ports are configured for the second carrier,
wherein N_{ID}^{Ncell} refers to the Physical layer Cell Identity (PCI) of the first cell and N_{ID}^{Cell} refers to the PCI of the second cell.

12. The method of claim 1, wherein the starting symbol for Narrowband Physical Downlink Shared Channel (NPDSCH) and/or Narrowband Physical Downlink Control Channel (NPDCCH) in the subcarriers of the second part of the first carrier is same as that in the subcarriers of the first part of the first carrier.

13. The method of claim 1, wherein one or more resource elements (REs) in the first carrier are reserved for CRS transmission associated with the second carrier.

14. The method of claim 13, wherein the one or more reserved REs comprise at least one RE in the second part of the first carrier.

15. The method of claim 13, wherein the one or more reserved REs comprise no RE in the second part of the first carrier.

16. The method of claim 1, wherein the data comprises at least one or more Narrowband Reference Signals (NRSs).

17. The method of claim 1, wherein the first carrier is a Narrow Band Internet of Things (NB-IoT) carrier and the second carrier is an Evolved Universal Terrestrial Radio Access (E-UTRA) carrier.

18. The method of claim 1, wherein the second cell is also served by the RAN node.

19. A RAN node, comprising:
a processor;
a memory storing instructions which, when executed by the processor, cause the processor to perform of:
broadcasting or transmitting, to one or more User Equipments (UEs), a first part of data in a first part of the first carrier that is overlapped with the second carrier and a second part of the data in a second part of the first carrier that is not overlapped with the second carrier.

20-21. (canceled)

22. The RAN node of claim 19, wherein the first carrier is an anchor carrier of the first cell.
